(19) United States
(12) Patent Application Publication
(10) Pub. No.: US 2007/0285720 A1
(43) Pub. Date: Dec. 13, 2007

(54) Flexible system for producing photo books

(76) Inventors: Joe M. Guglielmi, Burlingame, CA (US); Dan C. McCormick, Hillsborough, CA (US); Samuel R. Faillace, San Francisco, CA (US); Kyrie Robinson, Palo Alto, CA (US)

Correspondence Address: Xin Wen, 2800 Bridge Parkway, Redwood City, CA, 94065, US

(21) Appl. No.: 11/450,108

(22) Filed: Jun. 9, 2006

(51) Int. Cl. G06F 3/12

(52) U.S. Cl. 358/1.18; 358/1.15

(57) ABSTRACT

A data structure for a page configured to be incorporated into a photo book includes a first data field configured to store a position of an image on the page; a second data field configured to store information about an owner of the page; and a third data field configured to store a price associated with the page.

### BACKGROUND

In recent years, photography has been rapidly transformed from chemical based technologies to digital imaging technologies. Digital images captured by digital cameras can be stored in computers and viewed on electronic display devices. A user can upload his or her images to a central network location provided by an image service provider such as Shutterfly, Inc. at www.shutterfly.com. The user can store, organize, manage, edit, enhance, and share digital images at the central network location using software tools provided by the service provider. A user can also design and order image-based products from the image service provider. Image-based products can include image prints, photo books, photo calendars, photo mug, and photo T-shirt using his or her own images. Creating a memorable photo book can often be an involved and time-consuming task. A challenge in creating photo books is for users to produce proper content for the photo books.

### SUMMARY

In one aspect, the present application relates to a data structure for a page configured to be incorporated into a photo book. The data structure includes a first data field configured to store a position of an image on the page; a second data field configured to store information about an owner of the page; and a third data field configured to store a price associated with the page.

In another aspect, the present application relates to a user interface including a photo-book layout that includes a first area configured to receive a first image from a user; and a second area configured to receive a sellable page owned by one or more third parties, wherein the sellable page comprises at least one second image. The user interface also includes a first price associated with the sellable page and a second price associated with the photo book, wherein the second price is configured to dynamically change in response to the first price when the second area receives the sellable page.

In yet another aspect, the present application relates to a system for producing a photo book. The system includes a computer processor configured to incorporate a first image from a user into a first page of the photo book, to incorporate a sellable page into a second page of the photo book, and to compute a second price associated with the photo book in response to a first price associated with the sellable page, wherein the sellable page comprises one or more second images; and a computer device configured to transmit digital data to a display device to enable the display of a layout of the photo book, the first price, and the second price on the display device.

Implementations of the system may include one or more of the following. The data structure can further include a fourth data field configured to store an identification of the photo book that has incorporated the page. The data structure can further include a fifth data field configured to store an identification of a user that has created the photo book. The data structure can further include one or more text fields configured to store text at one or more text locations in the page. The data structure can further include one or more fourth fields configured to store a background design or a page layout for the page. The one or more fourth fields can be configured to store a plurality of background designs or page layouts that are selectable by a user to incorporate the page into the photo book. The second data field can be configured to store information about a plurality of owners each owning at least a portion of the page to be incorporated into the photo book. The third data field can be configured to store a plurality of prices associated with the page, wherein the prices are dependent on one or more of a size, a format, and a finish of the photo book.

Embodiments may include one or more of the following advantages. The disclosed system and methods provide a flexible infrastructure that allows users to create photo books incorporating their personal photo content and sellable page content that users can purchase from third-parties. A user can incorporate his or her digital images into the photo books. The sellable page is provided for the user to conveniently incorporate as pages into his or her photo book. The sellable page is owned by a third party and may carry a price for the usage in an image based product such as a photo book. The flexible infrastructure can properly account for the cost of the third-party pages in a photo book and dynamically compute the total price for the photo book.

Buyer-centric photo book creation is another advantage of the disclosed system and methods. While some conventional systems provide photo based products that may be customized for certain occasions by artists, the image users cannot incorporate their personal photo contents. The conventional customized image-based products are sold at fixed pricing since the designs of these products are predefine.

Another advantage of the disclosed system and methods is that the flexible network-based infrastructure is provided for users to create photo books. A user can upload his or her digital images to an internet service provider. The user can incorporate his or her digital images and develop other creative content for a photo book. The network-based infrastructure can also provide a large amount of third-party page content that the user can also browse and search using a web browser on the user's computer device. To facilitate the user's selections, the third-party page content can be categorized according to themes and occasions. The third-party page content can also be tagged with keywords that can be searched by the users.

### BRIEF DESCRIPTION OF THE DRAWINGS

FIG. 1 is a block diagram of a system for producing personalized image-based products in accordance with the present specification.

FIG. 2 shows a typical user's computer that can used in the system of FIG. 1.

FIG. 3 is a functional block diagram for creating a photo book using the system of FIG. 1.

FIG. 4 illustrates an exemplified web user interface that can be displayed on a user's computer for creating a photo book using the system of FIG. 1.

FIG. 5 illustrates an exemplified data structure for describing a sellable page that can be incorporated into a photo book created using the system of FIG. 1.

FIG. 6 is a flow diagram for creating a photo book using the system of FIG. 1.

Although the invention has been particularly shown and described with reference to multiple embodiments, it will be understood by persons skilled in the relevant art that various changes in form and details can be made therein without departing from the spirit and scope of the invention.

### DETAILED DESCRIPTION

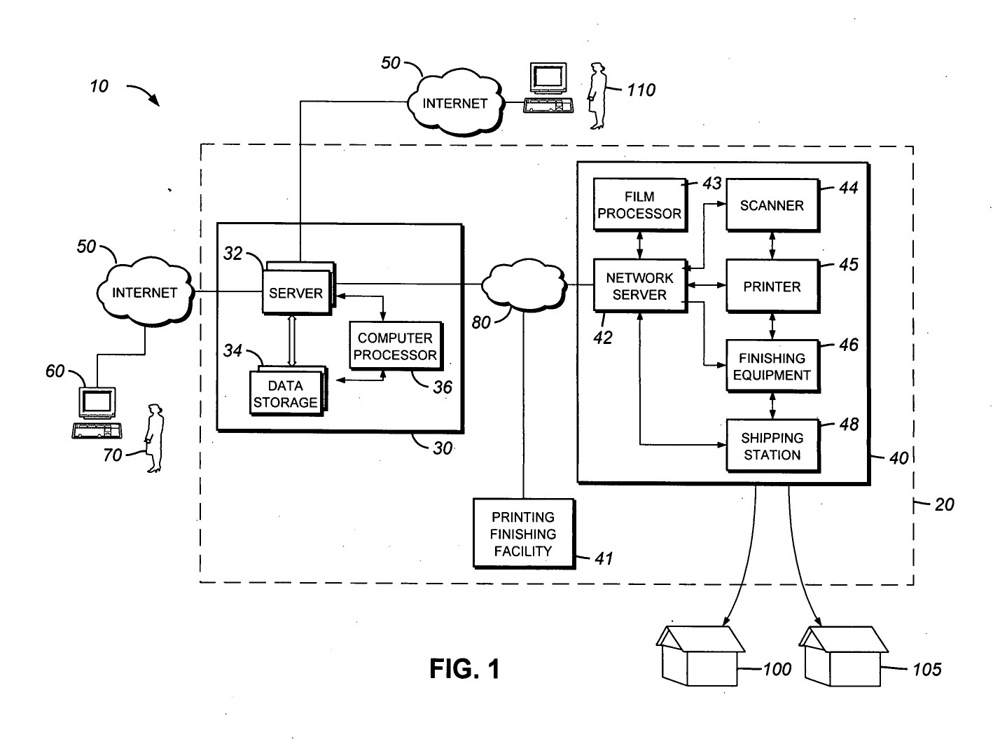

FIG. 1 shows a block diagram of a system 10 for producing personalized image-based products. An online photo system 20 is established by a photo service provider to provide photo services and products on a wide area network such as the Internet 50. The online photo system 20 includes a data center 30, one or more printing and finishing facilities 40 and 41, and a computer network 80 that can facilitate the communications between the data center 30 and the finishing facilities 40 and 41.

In the present specification, the term “personalized” is used in personalized content, personalized messages, personalized images, and personalized designs that can be incorporated in the personalized products. The term “personalized” refers to the information that is specific to the recipient, the user, the gift product, or the intended occasion. In other words, “personalized” information is “individualized” or “customized”, and is not generally applicable to all gift products. Examples of personalized image-based products may include personalized photo greeting cards, photo prints, photo books, photo T-shirt, and photo, mugs etc. The personalized image-based products can include users' photos and personalized text.

The term “photo book” refers to books that include one or more pages. At least one of the pages includes an image. Photo books can also be referred as photo albums, scrapbooks, photo calendar books, or photo snapbooks, etc. As described in detail below, the photo books in the disclosed system can include photo and text content provided by a user that creates the photo book or by a third party who makes the page content available for free or with a fee.

The data center 30 includes one or more servers 32, data storage devices 34 for storing image data, user account and order information, and one or more computer processors 36 for processing orders and rendering digital images. An online-photo website can be powered by the servers 32 to serve as a web interface between the users 70 and the photo service provider. The users can order image-based products from the web interface. The printing and finishing facilities 40 and 41 can produce the ordered image-based products such as photographic prints, greeting cards, photo albums, photo calendars, photo books, photo T-shirt, photo mugs, record images on compact disks (CDs), and framed photo prints. In accordance with the present specification, the greeting cards include folded greeting cards, postcards, trading cards such as baseball cards or game cards, and other form of cards. The users 70 can personalize their greeting cards by including an image uploaded from the website.

The architecture of the data storage devices 34 is designed to optimize the data accessibility, the storage reliability and the cost. Further details on the image data storage in online photo system 20 are provided in the commonly assigned U.S. patent application Ser. No. 09/428,871 filed Oct. 27, 1999, titled “Multi-Tier Data Storage System”, which is incorporated herein by reference.

The printing and finishing facilities 40 and 41 can be co-located at the data center 30. Alternatively, the printing and finishing facility 40 and 41 can be located remotely from the data center 30. The printing and finishing facilities 40 and 41 can be set up. Each printing and finishing facility 40 or 41 can be geographically located close to a large population of customers to shorten order delivery time. Furthermore, the printing and finishing facilities 40 and 41 and the data center 30 can be owned and operated by different business entities. For example, a first business entity can own the data center 30 and host the website that can be accessed by the users 70. The printing and finishing facilities 40 and 41 can be owned by a second business entity responsible for fulfilling the image-based products ordered through at the website. In this particular arrangement, the second business entity is often referred as an Application Service Provider (ASP).

The printing and finishing facility 40 can include one or more network servers 42, printers 45 for printing images on physical surfaces, finishing equipment 46 for operations after the images are printed, and shipping stations 48 for confirming the completion of the orders and shipping the ordered image-based products to the user 70 or recipients 100 and 105. The one or more network servers 42 can communicate with the data center 30 via the computer network 80 and facilitate the communications between different devices and stations in the printing and finishing facility 40. The computer network 80 can include a Local Area Network, a Wide Area Network, and wireless communication network.

The printers 45 can receive digital image data and control data, and reproduce images on receivers. The receivers can be separate photo prints, or pages to be incorporated into photo books. Examples of the printers 45 include can be digital photographic printers such as Fuji Frontier Minilab printers, Kodak DLS minilab printers, Gretag CYRA FastPrint digital photo printer, or Kodak I-Lab photo printers. The printers 45 can include offset digital printers or digital printing presses such as HP Indigo digital printing press, Xerox's IGen printer series etc. The printers 45 can also include large format photo or inkjet printers for printing posters and banners. The printing and finishing facilities 40 and 41 can include a film processor 43 for processing exposed films, and a scanner 44 for digitizing a processed film stripe. The order information and image data can be transferred from servers 32 to the network servers 42 using a standard or a proprietary protocol (FTP, HTTP, among others).

The finishing equipment 46 can perform any operations for finishing a complete image-based product other than photo printing such as cutting, folding, adding a cover to photo book, punching, stapling, gluing, binding, envelope printing and sealing, packaging, labeling, package weighing, and postage metering. The finishing operations can also include framing a photo print, recording image data on a CD-ROM, etc. Furthermore, the printers and the finishing equipments can reside in different locations.

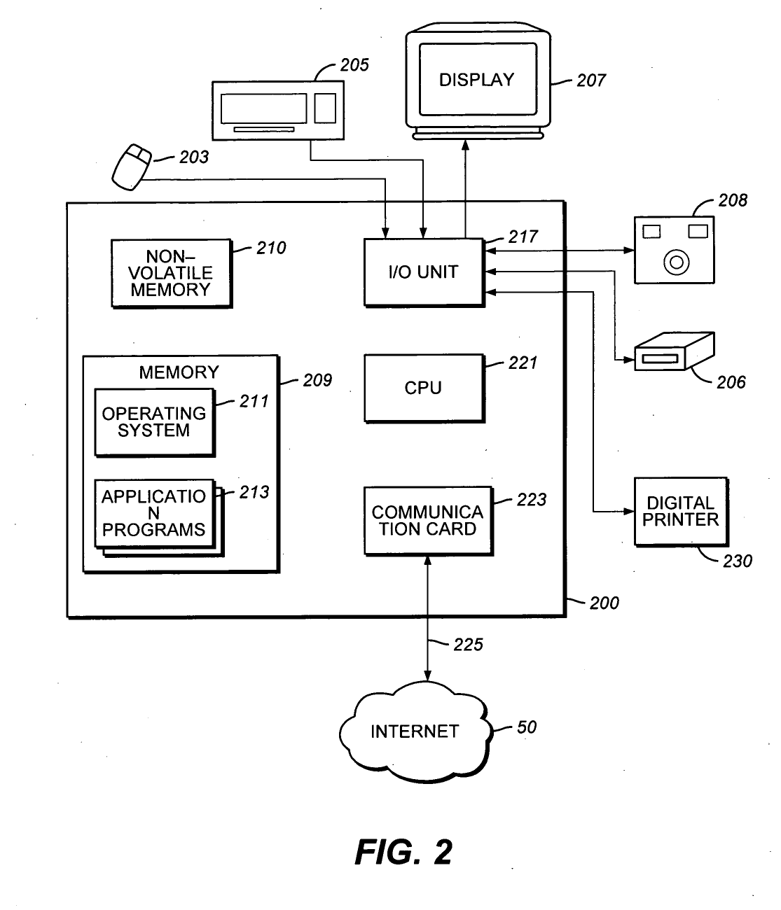

A user 70 can access the online-photo website using a computer terminal 60 as shown in FIG. 2. The computer terminal 60 can be a personal computer, a portable computer device, or a public entry terminal such as a kiosk. The computer terminal 60 allows a user 70 to execute software to perform tasks such as communicating with other computer users, accessing various computer resources, and viewing, creating, or otherwise manipulating electronic content, that is, any combination of text, images, movies, music or other sounds, animations, 3D virtual worlds, and links to other objects. Exemplary components of the computer terminal 60, shown in FIG. 2, include input/output (I/O) devices (mouse 203, keyboard 205, display 207) and a general purpose computer 200 having a central processor unit (CPU) 221, an I/O unit 217 and a memory 209 that stores data and various programs such as an operating system 211, and one or more application programs 213 including applications for viewing, managing, and editing digital images (e.g., a graphics program such as Adobe Photoshop). The computer 200 also includes non-volatile memory 210 (e.g., flash RAM, a hard disk drive, and/or a floppy disk, CD-ROM, or other removable storage media) and a communications device 223 (e.g., a modem or network adapter) for exchanging data with an Internet 50 via a communications link 225 (e.g., a telephone line).

The computer 200 allows the user 70 to communicate with the online-photo website using the communications card or device 223. The user 70 can set up and access her personal account. The user 70 can enter user account information such as the user's name, address, payment information (e.g. a credit card number), and information about the recipient of the image-based products. The user 70 can also enter payment information such as credit card number, the name and address on the credit card etc. The user 70 can upload digital images to the online-photo website. The user can store the images in an online photo album, create personalized image-based product at the web user interface, and order a personal image-based product and a gift product for specified recipients 100 and 105.

The computer 200 can be connected to various peripheral I/O devices such as an image capture device (digital camera, film scanner or reflective scanners). The peripheral device can be a digital camera 208. The digital images captured by a digital camera are typically stored in memory card (e.g., SmartMedia™ or CompactFlash™) that are detachable from the digital camera. The digital images on a memory card can be transferred to the computer 200 using a card reader 206 and saved on non-volatile memory 210. The digital camera 208 can also be directly connected to the computer 200 to allow digital images to be transferred from the memory on the detail camera to the computer's disk drive or other non-volatile memory 210. The digital camera 208 can be connected to the computer 200 using a Firewire or an USB port, a camera docking station, or a wireless communication port.

The user 70 can also obtain digital images from film-based prints from a traditional camera, by sending an exposed film into a photo-finishing service, which develops the film to make prints and/or scans (or otherwise digitizes) the prints or negatives to generate digital image files. The digital image files then can be downloaded by the user or transmitted back to the user by e-mail or on a CD-ROM, diskette, or other removable storage medium. The users can also digitize images from a negative film using a film scanner that is connected to the computer 200 or from a reflective image print using a scanner. Digital images can also be created or edited using an image software application 213 such as Adobe Photoshop.

Once the digital images are stored on the computer 200, a user can perform various operations on the digital images using application programs 213 stored in memory 209. For example, an image viewer application can be used for viewing the images and a photo editor application can be used for touching up and modifying the images. An electronic messaging (e.g., e-mail) application can be used to transmit the digital images to other users. The application programs 213 can also enable the user 210 to create a personalized image-based product on the computer 200. Several of the above described imaging functions can be incorporated in a client software application. The client software can be distributed by the photo service provider and installed on user' computer 200.

In addition to viewing the digital images on the computer display 207, the user 70 may desire to have physical image-based products made of digital images. Prints can be generated by the user 70 using a digital printer 230 that is connected to the computer 200. Typical digital printers 230 can include such as an inkjet printer or a dye sublimation printer. The user 70 can also purchase image-based products from the online photo service provider. The production of these image-based products often require the use of commercial equipment which are usually only available at a commercial production location such as the printing and finishing facilities 40 and 41. One online photo service provider that makes such image-based products is Shutterfly, Inc., located at Redwood City, Calif.

The user 70 can be a consumer that accesses the computer terminal 60 from home or a public entry terminal. The user 70 can also be a business owner or employee that may access the computer terminal 60 at a retail location such as a photo shop or a printing store. The disclosed system is compatible with a retail imaging service using a local computer 200 at the point of sales, or an online photo system wherein a user 70 access a server 32 using a remote computer terminal 60. The formats of communication between the computer terminal 60 and the servers 32 as well as the graphic user interface can be customized for the consumer and commercial customers.

The computer terminal 60 can also be a public entry terminal such as a kiosk for receiving digital image data from the user 70 and uploading the digital images to the server 32. After the digital image files have been uploaded, the user can view, manipulate and/or order prints in the manners described above. The public entry terminal can also support various electronic payment and authorization mechanisms, for example, a credit or debit card reader in communication with a payment authorization center, to enable users to be charged, and pay for, their prints at the time of ordering.

An exemplified process of using the online photo service can include the following. The user 70 sends digital images to the servers 32 provided by the online photo system 20 by uploading over the Internet 50 using a standard or a proprietary protocol (FTP, HTTP, XML, for example) or electronic communication application (for example, e-mail or special-purpose software provided by the photo-finisher). The user 70 can also send digital image data stored on a physical storage medium such as a memory card or recordable CD by US mail, overnight courier or local delivery service. The photo-finisher can then read the images from the storage medium and return it to the user, potentially in the same package as the user's print order. The photo service provider can load data or programs for the user's benefit onto the storage medium before returning it to the user. For example, the photo-finisher can load the storage medium with an application program 213 for the user to create a personalized image-based product on his computer 200.

The user 70 can also send a roll of exposed film, and processed film negatives to the photo service provider. The exposed film is processed by the film processor 43 and digitized by the scanner 44 in the printing and finishing facilities 40 and 41. The digital image data output from the scanner 44 is stored on the data storage 34.

After the photo service provider has received the user's digital images, the photo service provider can host the images on the online photo website, at which the user can view and access the images using a browser application. The user 70 accesses the online-photo website to designate which of the images should be reproduced on a image-based product, parameters relating to printing (e.g., finish, size, number of copies), and one or more recipients 100 and 105 to whom the image-based products are to be sent.

In addition to hosting the user's images on a web page, the photo service provider usually stores the images in an image archive on in the data storage 34 so that the user 60 and others given authorization by the user (e.g. the share recipient 110) can access them in the future. The photo service provider can also provide sample images for the users to select for use online or producing a physical image-based product.

After the user's images have reached the photo service provider and have been made available online, the user can place an order with the photo service provider. One way to place an order is by having the user 70 view the images online, for example, with a browser and selectively designate which images should be printed. The user can also specify one or more recipients 100 and 105 to whom prints should be distributed and, further, print parameters for each of the individual recipients, for example, not only parameters such as the size, number of copies and print finish, but potentially also custom messages to be printed on the back or front of a print.

The information stored in the data storage 34 is provided to a printing and finishing facility 40 or 41 for making the image-based products. The image-based products include photographic prints, but also any other item to which graphical information can be imparted, for example, greeting or holiday cards, books, greeting cards, playing cards, T-shirts, coffee mugs, mouse pads, key-chains, or any other type of gift or novelty item. The image-based products are printed by the printer 45 and finished by finishing equipment 46 according to the printing parameters as specified by the user 70. The image-based products are then delivered to the specified recipients 100 and 105 using standard U.S. Mail, or courier services such as Federal Express or UPS.

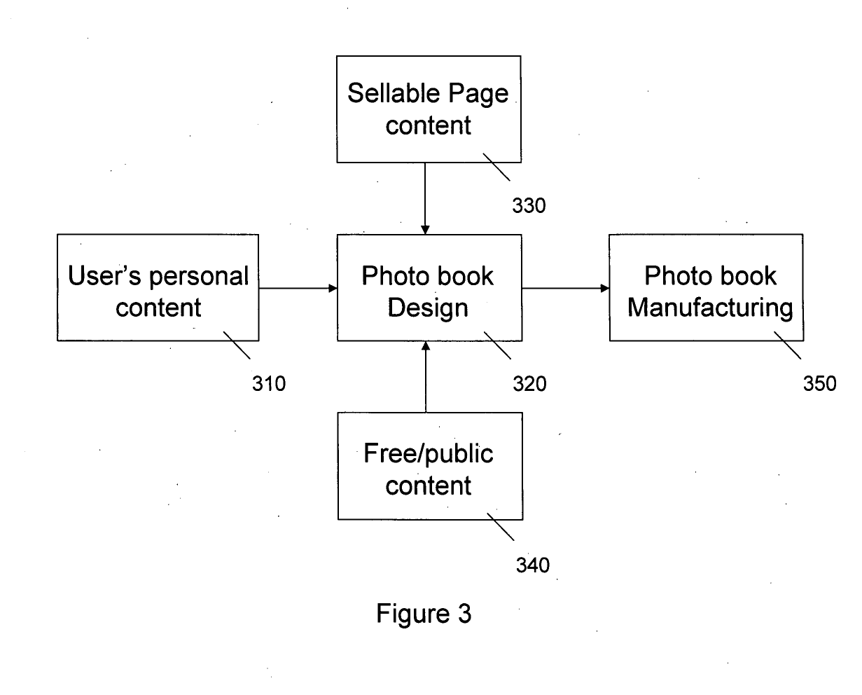

FIG. 3 illustrates a functional block diagram for creating a photo book using the system 10. As described above, the user 70 can provide user's personal content 310 to be incorporated in the design 320 of a photo book. In the present specification the user can be an individual consumer, a person representing a business, or a person representing a non-profit organization such as a charity group. The personal content can include digital images uploaded by the user to the web site, designs the user created, and text that the user can enter at the web user interface. The photo book design 320 can also incorporate page content from third parties, which can include sellable page content 330 and free/public content 340. The sellable page content 330 are page designs that can be provided by artists and professional photographers, creative users in the community serviced by the same photo service provider, or licensed from image-asset owning companies such as Corbis or Disney. The completed book design therefore include a combination of content from the user herself as well as page content from third parties other than the user. Finally, the completely designed photo book can be manufactured 350 in the printing and finishing facilities 40 and 41.

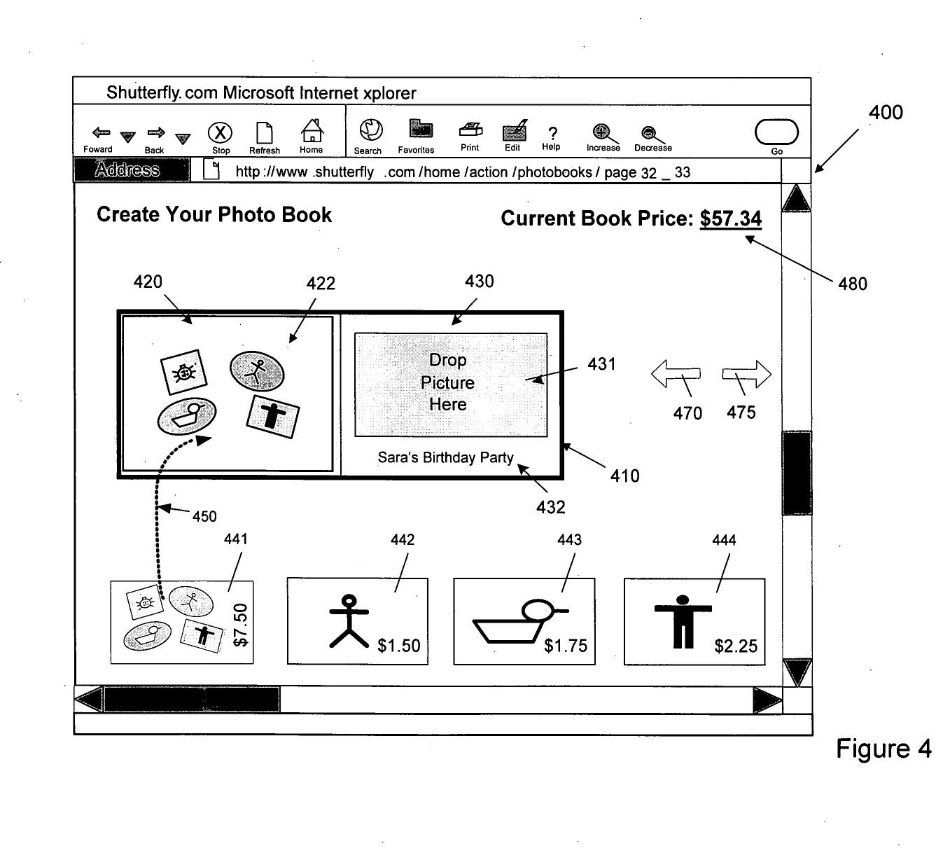

FIG. 4 illustrates an exemplified user interface 400 for creating a photo book using the system 10. The user interface 400 can be displayed on a user's computer 60 using data produced by the server 32 in the data center 30. The user interface 400 includes a photo book layout 410 for pages 420 and 430. In general, the user interface 400 can provide a plurality of page layouts for the user to select for one or more pages in the photo book. The page 420 includes a receiving area 422 that is configured to receive page content. The page 430 includes a text area at which the user 70 can enter a text line like “Sara's Birthday Party”. The page 430 also includes an image receiving area 431 that can receive from the user an image taken at the birthday party. The user may also incorporate in the page 430 a background design produced by the user or provided by the photo service provider.

The user interface 400 also provides a plurality of sellable pages 441-444 that can each display a list price such as “$0.75”, “$1.50”, “$1.75”, or “$2.25”that the user is to pay if the particular page content is to be incorporated in the photo book 410. The sellable page 441, 442, or 444 is an integral object that is defined by a data structure (as discussed below) and can be incorporated as a full page into a photo book. The sellable page is pre-designed by one or more owners who own the copyright of the sellable page. In contrast to a stock photo, the sellable pages 441, 442, or 444 include the content for a full page layout which may include multiple image and text objects as well as a background design. Because of the copyright ownership involved, the content of the sellable page is usually not allowed to be edited by a user unless permission has been given by the owner of the sellable page. In some embodiments, the original owner of the sellable page may permit the sellable page she owns to be improved by a second artist. The improved sellable page can be a new sellable page that is jointly owned by the original owner and the second artist.

The disclosed system provides means for artists to sell pages not as a final image product (a photo book), but as a component that can be purchased by users and incorporated into image products (a photo book). The disclosed system provides ways to maintain the integrity of and define the pricing for the sellable pages, which enable the sellable pages to be purchased by the creators of the photo books from the owners of the sellable pages. In another aspect, the disclosed system and methods create a new product type of sellable pages which provides content source for the photo book creators and produces a new customer segment for the artist or creative users.

The user can select one of the sellable pages 441-444 by clicking a mouse on one of the sellable pages 441-444. The user can use the mouse to drag one of the sellable pages 441-444 and drop it in the receiving page 422 through path 450. In one embodiment, the price of the sellable pages can vary in accordance with the size, the format, and the finish of the physical photo book to be manufactured.

The sellable page content 441-444 can be categorized by occasions or themes such as wedding, babies, graduation, Halloween, Mother's Day. The sellable page content 441-444 can also be rank by popularity among the users. The sellable page content 441-444 can also each be tagged with one or more keywords which allow them to be searched by the users.

The current total price 480 of the photo book can be computed and displayed on the user interface 400. The computation of the total price takes into account the prices of the sellable page content that has been incorporated into the photo book 410. The total price can also depend on the number of pages, the dimensions, the page finish, and the book cover finish of the photo book 410.

The user can actuate the arrow icons 470 and 475 to design and view other pages of the photo book 410. After the design of the photo book 410 is completed, it can be previewed in planar or perspective views. The user has the option to select and change the finish of the color and the material of the photo book and the finish of the pages 420 and 430. The user interface 400 can also include an icon that the user 70 can click with a mouse to order the photo book. The photo book will be manufactured by a printing finishing facility 40 or 41 in response to designs of the pages 420 and 430 and other parameters specified by the user 70.

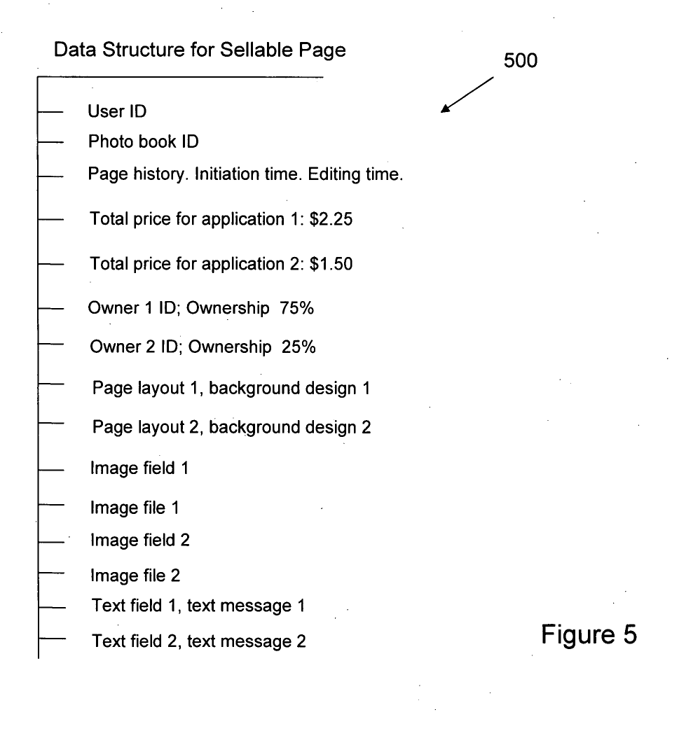

FIG. 5 illustrates an exemplified data structure 500 for describing a sellable page that can be incorporated in a photo book created using the system 10. The data structure 500 can be stored in the computer processor 36 or the data storage 34 in the data center 30. The data structure 500 for a sellable page can include a user ID of the user 70 who has chosen the sellable page in her photo book product. The user ID is left blank if the sell page is not selected to be used in a photo book by a user yet. The data structure 500 for the sellable page also includes the history of the sellable page, for example, the times when the sellable page was created, edited, and so on. In general, more than one person can contribute and share the ownership of the sellable page. For example, two owners Owner 1 and owner 2 can each own certain percentage or fixed dollar amounts of the sellable page. For example, owner 1 may be the original creator of the sellable page and owns 75% of the sellable page. Owner 2 may have contributed additional features to the sellable page with the consent owner 1 and the photo service provider. Owner 2 may own 25% of the sellable page. The ownership can also define the amount of the price to be paid to the photo service provider that provides the infrastructure and services. The ownership arrangement can be stored in the data structure 500 as shown in FIG. 5.

In some embodiments, the owner(s) of a sellable page can flexibly set the price of the sellable page. The photo service provider can provide a user interface for the owner(s) so set the price of the sellable page under a set of policies (or rules). For example, a sellable page for a 16″×16″ photo-book application is allowed to set the price in the range of a minimum of $1.00 to a maximum of $3.00, wherein $1.00 is the share of the revenue the photo service provider will receive after the photo book including the sellable is manufactured and shipped. Details about the price setting by a owner of a image-based produce is disclosed in commonly assigned U. S. patent application Ser. No. 10/465,185, filed on Jun. 19, 2003, titled “Automated printing system for producing copyright protected image-based product”, the disclosure of which is incorporated herein by reference.

As mentioned above, the price for the sellable page can vary according to applications or the formats of the image-based product in an application. For example, the price of the sellable page may vary depending whether the product is a photo book, snapbook, a calendar book, or a scrapbook. The price can also vary in accordance to the size, the finish, and the layout of the photo books. The price of the sellable page can also vary depending on the theme or the occasion of the photo book.

Furthermore, the data structure 500 can include a page layout and/or a background design. The background design may for example be applicable to a particular them or occasion such as wedding, graduation, and babies. In some embodiments, the data structure 500 can store a plurality of page layouts (page layout 1, page layout 2 . . . ) and a plurality of background designs which are provided for a user (or purchaser) of the sellable page to select before incorporating into her photo book. The data structure 500 can store the locations for one or more image fields, as well as the file names and the image storage locations (e.g. an URL) of the digital images at these image fields. The data structure 500 can also store one or more text messages and their respective text-field locations. The locations of the image fields and the digital images can be dynamically defined by the choice of the background design and the page layout as selected by the user.

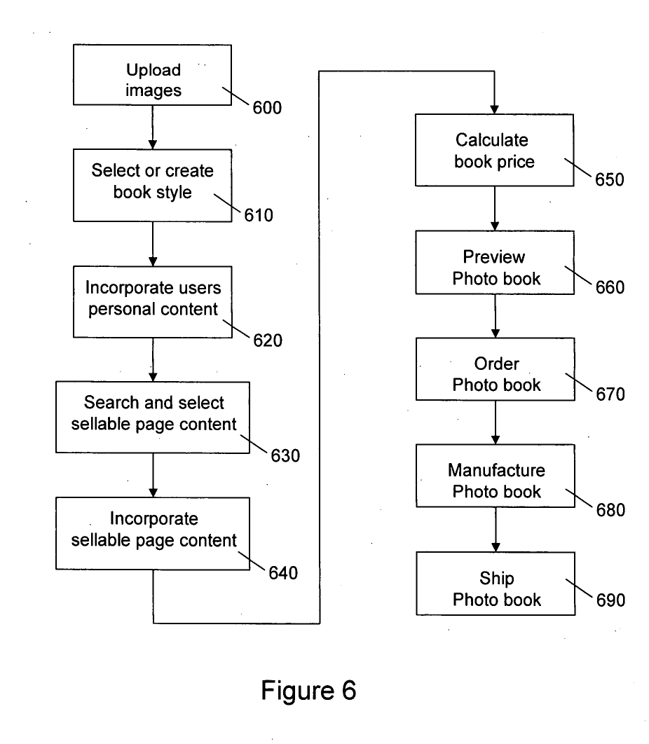

FIG. 6 is a flow diagram for creating a photo book using the system 10. A user can transfer digital images from a digital camera or obtained a digital image from a scanner. The user can upload his or her digital image to the server 32 in the data center 30 provided by the photo service provider (step 600). In the book creation process, the user can select or create a photo book style for the photo book (step 610). The photo book style can be selected from a plurality of designs. The photo book style can be specific to the occasions (wedding, birthday, graduations, holidays, etc.). The user can supply her content such as images, text, and page background to the photo book (step 620). The user can next search and select sellable page content (step 630) and incorporate the sellable page content into the photo book (step 640). The price of the photo book can be calculated dynamically (step 650) through the creation process. The calculation takes into account the price of the sellable page content that has been incorporated into the photo book. The user can preview the photo book in planar or perspective views (step 660) after the photo book design is completed. The user orders the photo book (step 670). The photo book is manufactured using the book design, the sellable page content incorporated, and personal content provided by the user (step 680). The photo book is shipped one or more recipients specified by the user (step 690).

It is understood that the above disclosed system and methods can be implemented in various forms without deviating from the spirit of the specification. For instance, the system can be implemented on a computer system local to the user. The user interface, data structure, and the dynamic price computation can be implemented by a display device, a storage device, and a processor associated with the local computer system. The computer system can be installed at a retail shop. Book manufacturing and finishing equipment may also be provided at the retail shop for producing the photo books.

Furthermore, more than one user can be involved in the creation of a photo book incorporating personal photo content and sellable pages from a third party. The users can collaborative create the photo book using a local computer system or a network-based system. Details about how users can collaboratively create photo books are disclosed in the commonly assigned U. S. patent application Ser. No. 11/207,666, filed on Aug. 19, 2005, titled “System and methods for collaborative scrapbook creation”, the disclosure of which is incorporated herein by reference.

What is claimed is:

1. A data structure for a page configured to be incorporated into a photo book, comprising:
a first data field configured to store a position of an image on the page;
a second data field configured to store information about an owner of the page; and
a third data field configured to store a price associated with the page.

2. The data structure of claim 1, further comprising:
a fourth data field configured to store an identification of the photo book that has incorporated the page.

3. The data structure of claim 2, further comprising:
a fifth data field configured to store an identification of a user that has created the photo book.

4. The data structure of claim 1, further comprising:
one or more text fields configured to store text at one or more text locations in the page.

5. The data structure of claim 1, further comprising:
one or more fourth fields configured to store a background design or a page layout for the page.

6. The data structure of claim 5, wherein the one or more fourth fields are configured to store a plurality of background designs or page layouts that are selectable by a user to incorporate the page into the photo book.

7. The data structure of claim 1, wherein the second data field is configured to store information about a plurality of owners each owning at least a portion of the page to be incorporated into the photo book.

8. The data structure of claim 1, wherein the third data field is configured to store a plurality of prices associated with the page, wherein the prices are dependent on one or more of a size, a format, and a finish of the photo book.

9. A user interface, comprising:
a photo-book layout comprising:
a first area configured to receive a first image from a user; and
a second area configured to receive a sellable page owned by one or more third parties, wherein the sellable page comprises at least one second image;
a first price associated with the sellable page; and
a second price associated with the photo book, wherein the second price is configured to dynamically change in response to the first price when the second area receives the sellable page.

10. The user interface of claim 9, wherein the photo-book layout comprises one or more text fields configured to receive one or more text information to be incorporated into the photo book.

11. The user interface of claim 9, further comprising:
one or more icons configured to be actuated by the user to allow the user to view or edit different pages of the photo book.

12. The user interface of claim 9, further comprising:
one or more page layout configured to be selected by the user for one or more pages in the photo book.

13. The user interface of claim 9, further comprising:
one or more sellable pages configured to be selected to be moved to the second area of the photo-book layout, wherein each of the one or more sellable pages is associated with a page price.

14. The user interface of claim 9, further comprising:
an icon actuatable by a user to initiate the manufacturing of the photo book in response to the first image on the first page of the photo book and the sellable page incorporated into the second page of the photo book.

15. A system for producing a photo book, comprising:
a computer processor configured to incorporate a first image from a user into a first page of the photo book, to incorporate a sellable page into a second page of the photo book, and to compute a second price associated with the photo book in response to a first price associated with the sellable page, wherein the sellable page comprises one or more second images; and
a computer device configured to transmit digital data to a display device to enable the display of a layout of the photo book, the first price, and the second price on the display device.

15. The system of claim 14, wherein the computer device is a computer server and the display device is disposed at a remote location relative to the computer server.

17. The system of claim 15, wherein the display device is configured to display a user interface comprising:
the layout of the photo book, comprising:
a first area configured to receive the first image from a user; and
a second area configured to receive the sellable page owned by one or more third parties,
wherein the sellable page comprises at least one second image;
the first price associated with the sellable page;
the second price associated with the photo book, wherein the second price is configured to dynamically change in response to the first price when the second area receives the sellable page; and
one or more text fields configured to receive one or more text information to be incorporated into the photo book.

18. The system of claim 15, further comprising:
a computer storage device configured to store a data structure comprising:
a first data field configured to store a position of the second image in the sellable page;
a second data field configured to store information about an owner of the sellable page; and
a third data field configured to store the first price associated with the sellable page.

19. The system of claim 15, wherein the computer processor is configured to compute the second price associated with the photo book in accordance with one or more of the dimensions, the number of pages, the page finish, and the book cover of the photo book

20. The system of claim 15, further comprising:
equipment configured to manufacture the photo book in response to the first image on the first page of the photo book and the sellable page incorporated into the second page of the photo book.
